(19) United States
(12) Patent Application Publication
(10) Pub. No.: US 2005/0260884 A1
(43) Pub. Date: Nov. 24, 2005

(54) USB transmission cable having a power display

(75) Inventor: Wen-Hsiang Yueh, Linkou Township (TW)

Correspondence Address: BACON & THOMAS, PLLC, 625 SLATERS LANE, FOURTH FLOOR, ALEXANDRIA, VA, 22314, US

(73) Assignee: Partner Tech. Corporation, Taipei County (TW)

(21) Appl. No.: 11/124,087

(22) Filed: May 9, 2005

(30) Foreign Application Priority Data
May 10, 2004 (TW) 93207237

(51) Int. Cl. H01R 3/00

(52) U.S. Cl. 439/488

(57) ABSTRACT

The present invention provides a UBS transmission cable having a power display, comprising a computer-end plug and a device-end plug, wherein the device-end plug internally comprises a signal detection-and-display circuit, and then the circuit drives an indicator for the user to confirm the power supply status of the transmission cable.

### FIELD OF THE INVENTION

The present invention relates to a USB transmission cable, and more particularly to an improved USB transmission cable capable of detecting and displaying power supply status of transmission data.

### BACKGROUND OF THE INVENTION

Since the emergency of USB interface, with advantages of high-speed transmission and connection to more than one hundred peripherals in series, the majority of computers and peripherals all use the standard interface. In addition to these, electronic dictionaries, PDAs (personal digital assistants), digital cameras, flash drives, MP3 players, and recording pens also adopt the USB interface. It is not difficult to relate the popularity of the USB interface in the market nowadays to its high-speed transmission speed. Taking the digital cameras in the market as an example, the majority of the storage is made available by incorporating a memory card into the USB interface, wherein the memory card is used as the storage medium for digital image data whereas the USB interface is used to load the data stored in the camera-built-in memory or the memory card to the computer. However, the majority of users feel puzzled by this device because the number and quality of photographs taken by the digital camera are related to the capacity of the memory or memory card built into the camera; moreover, the price of memory cards is directly proportional to their capacity, which suggests that when the users have the need to take a large number of photographs or high quality photographs, it is necessary to prepare a memory card of sufficient capacity. Nowadays, the emergency of USB greatly benefits people. When the capacity of the memory or memory card built into the camera is not sufficient, it is now possible to first load the data into the computer or other storage devices such as flash drives via USB interface and transmission cables, so as to allow space for continuous use. Although this method can solve the capacity issue of memory card, the following drawbacks are inherent in it: once the USB transmission cable 1 has been connected, it is difficult to tell whether the data at the two ends have been normally transmitted. Unless another USB transmission cable 1 is used, it is not possible to confirm if this is the trouble of the computer-end plug 2 or the device-end plug 3 of the USB transmission cable 1, or the transmission cable 5. Hence, it is difficult to use this device.

### SUMMARY OF THE INVENTION

As it is not possible for users to tell if it is the trouble of the USB transmission cable, or some other factors, once the trouble occurs. Hence, when the conventional USB transmission cable is used together with peripherals, it is not easy to know if the USB transmission cable is at normal operation status, and thus it is necessary to replace it with another conventional USB transmission cable in order to know if it is the trouble of the USB transmission cable.

To overcome the above-mentioned shortcomings, it is the primary object of the present invention to provide a USB transmission cable capable of detecting and displaying the data transmission status by means of a power display.

It is another object of the present invention to provide a USB transmission cable capable of detecting and displaying the data transmission status, and once a current is supplied to said transmission cable, it will become luminescent.

To achieve the aforementioned objects of the present invention, the present invention provides a USB transmission cable comprising a signal detection-and-display circuit in the device-end plug of the USB transmission cable so as to detect and display the power supply status, and further indicate whether the signal transmission status between the computer-end plug and the device-end plug is normal.

To achieve the aforementioned objects of the present invention, the transmission cable wraps round the signal line between the computer-end plug and the device-end plug, and the transmission cable further comprises electro-luminescent materials with transparent plastics as the outer structure, so that once a current is supplied to the USB transmission cable, the electro-luminescent materials of the transmission cable becomes luminescent.

A preferred embodiment of the present invention provides a USB transmission cable wherein the device-end plug internally comprises a signal detection-and-display circuit, and the signal detection-and-display circuit comprises a light-emitting diode and a resistor, wherein the light-emitting diode and the resistor are connected in series between the power cord and the ground wire; when data is transmitted via the connecting cables of the USB cable, the light-emitting diode will be conducted and become luminescent, so that the user can detect if the signal transmission status between the computer-end plug and the device-end plug is normal by detecting the luminescence of the light-emitting diode.

Another preferred embodiment of the present invention provides a USB transmission cable wherein the signal detection-and-display circuit comprises a light-emitting diode and a transistor, wherein the base of the transistor is cross-connected to the data line of the USB transmission cable via a resistor; the collector of the transistor is connected to the light-emitting diode and then connected to the power cord of the USB transmission cable via the light-emitting diode and a resistor; the emitter of the transistor is connected to the ground wire of the USB transmission cable; once data is transmitted via the connecting cables of the USB transmission cable, the transistor will be conducted, and a current is then supplied to the light-emitting diode, which thus becomes luminescent. Hence, the user can check if the signal transmission status between the computer-end plug and the device-end plug is normal by detecting the luminescence of the light-emitting diode.

Another preferred embodiment of the present invention provides a USB transmission cable having a power display, wherein a luminescent material is filled between the outer tube and the inner tube, and a current is then supplied to the power cord to stimulate the photons of the luminescent material, so that the user can confirm the power supply status of the transmission cable.

### BRIEF DESCIPTION OF THE DRAWINGS

The structure and the technical means adopted by the present invention to achieve the above and other objects can be best understood by referring to the following detailed description of the preferred embodiments and the accompanying drawings, wherein

FIG. 1 depicts an external structural view of a conventional USB transmission cable.

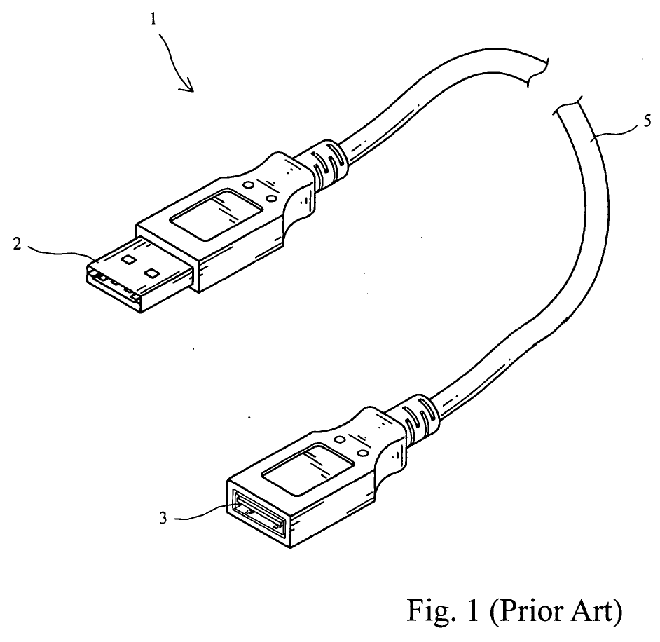

FIG. 2 is an external structural view of the USB transmission cable having a power display disclosed in the first embodiment of the present invention.

FIG. 3 is a view of the internal circuit of the USB transmission cable disclosed in the first embodiment of the present invention.

FIG. 4 is a view of the internal circuit of another embodiment in the USB transmission cable disclosed in the first embodiment of the present invention.

FIG. 5 is a partial cross-sectional view of the USB transmission cable having a power display disclosed in the second embodiment of the present invention.

### DETAILED DESCRIPTION OF THE PREFERRED EMBODIMENTS

While the invention has been described by way of examples and in terms of To the contrary, it is intended to carry out various modifications and similar arrangements and procedures, and the scope of the appended claims therefore should be accorded the broadest interpretation so as to encompass all such modifications and similar arrangements and procedures.

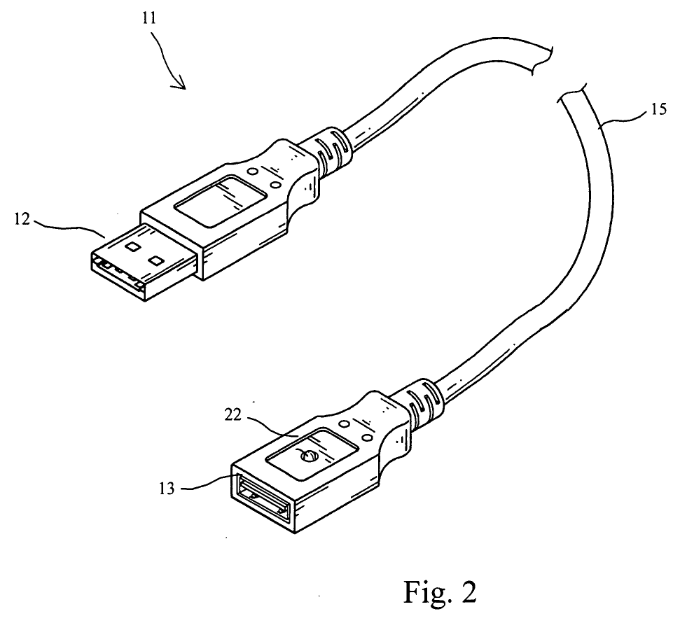

Please refer to FIG. 2, which depicts an illustration of the USB transmission cable 11 having a power display disclosed in the present invention. A light-emitting diode 22 is disposed on the device-end plug 13, so as to display the transmission status; wherein the computer-end plug 12 can plug into the USB port of a first electronic device such as a computer (PC) system, and the device-end plug 13 can plug to the USB port of a second electronic device, such as a digital camera, a PDA, a recording pen, and a flash drive; a transmission cable 15 is used to connect the computer-end plug 12 and the device-end plug 13 for data transmission.

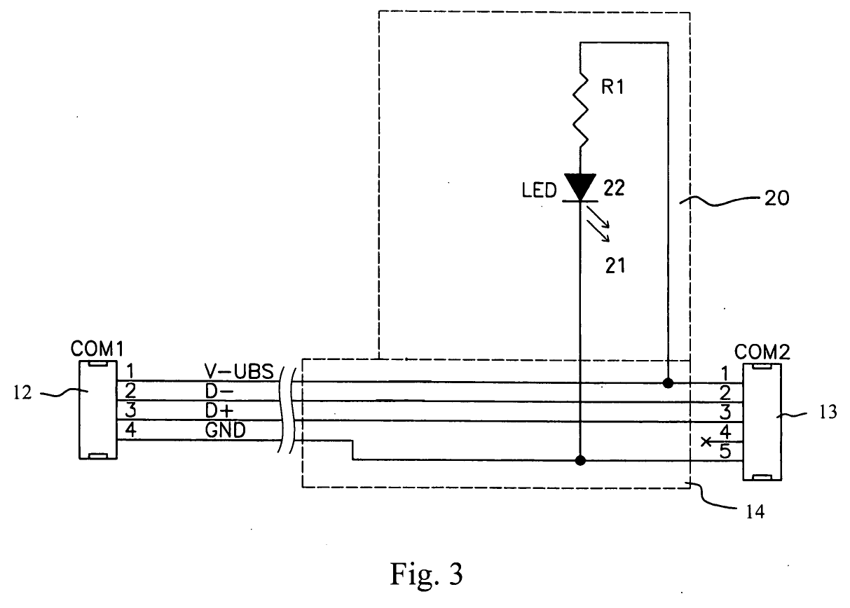

Please refer to FIG. 3, which depicts a view of the internal circuit of the USB transmission cable disclosed in the first embodiment of the present invention. A signal detection-and-display circuit 20 is cross-connected to a connecting wire 14, and the signal detection-and-display circuit 20 comprises a light-emitting diode 22 and a resistor R1, wherein the light-emitting diode 22 and the resistor R1 are connected in series between the power cord (V-USB) and the ground wire (GND).

Under the above circuit architecture, when data is transmitted via the connecting wire 14 between the computer-end plug 12 and the device-end plug 13, a current is then supplied to the light-emitting diode 22, which thus becomes luminescent, if no data is transmitted via the connecting wire 14 between the computer-end plug 12 and the device-end plug 13, no electric current is supplied to the light-emitting diode 22, which is thus unable to become luminescent.

With the above-mentioned design, the user can detect if the signal transmission status between the computer-end plug 12 and the device-end plug 13 is normal by detecting the luminescence of the light-emitting diode 22.

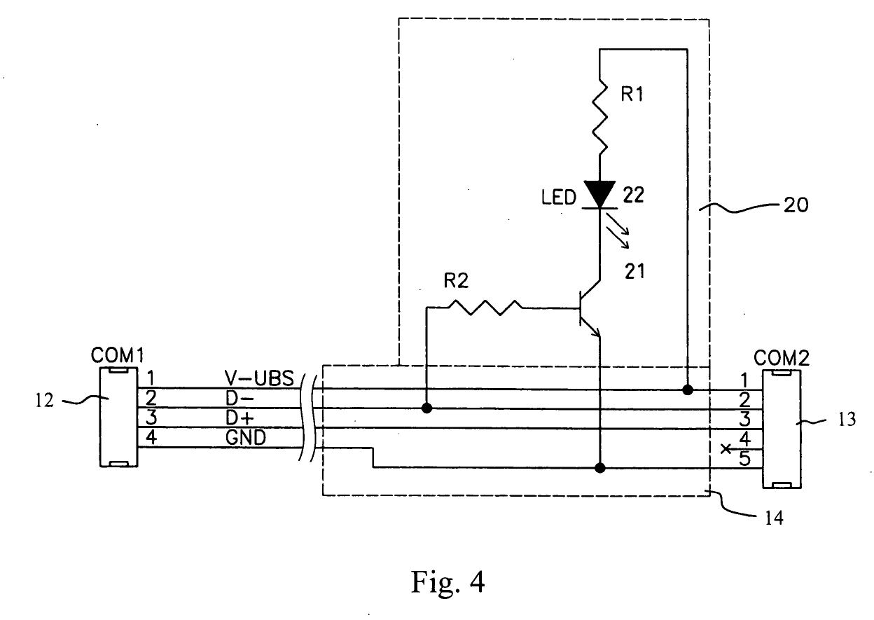

Please refer to FIG. 4, which a view of the internal circuit of another embodiment in the USB transmission cable disclosed in the first embodiment of the present invention. A signal detection-and-display circuit 20 is cross-connected to the connecting wire 14, and the detection-and-display circuit 20 comprises a transistor 21 and a light-emitting diode 22, wherein the base of the transistor 21 is cross-connected to the data wire (-D) of the connecting wire 14 via a resistor R2; the collector of the transistor 21 is connected in series to the light-emitting diode 22 and a resistor R1 and then connected to the power wire (V-USB) of the connecting wire 14, the emitter of the transistor 21 is connected to the ground wire (GND) of the connecting wire 14.

Under the above circuit architecture, when data is transmitted via the connecting wire 14 between the computer-end plug 12 and the device-end plug 13, a current is then supplied to the light-emitting diode 22, which thus becomes luminescent, if no data is transmitted via the connecting wire 14 between the computer-end plug 12 and the device-end plug 13, no electric current is supplied to the light-emitting diode 22, which is thus unable to become luminescent.

With the above-mentioned design, the user can detect if the signal transmission status between the computer-end plug 12 and the device-end plug 13 is normal by detecting the luminescence of the light-emitting diode 22.

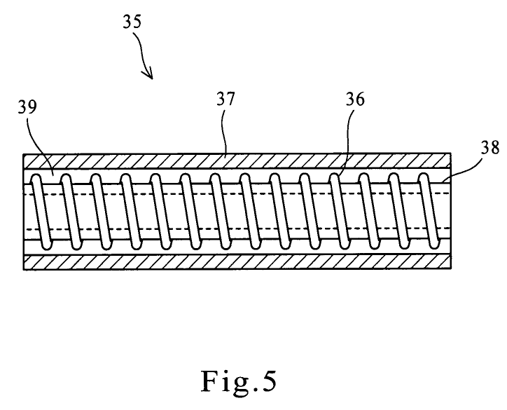

Please refer to FIG. 5, which is a partial cross-sectional view of the USB transmission cable having a power display disclosed in the second embodiment of the present invention, wherein the power cord 36 is wound round the external surface of the inner tube 38, and is evenly wound according to the helical way as shown in FIG. 5; the transmission cable 35 evenly and completely enables the electro-luminescent materials 39 (its scientific name is called EI, which is a type of luminescent material and appears as powdered paste under a normal state) to be filled between the outer tube 36 and the inner tube 37; USB signal lines are wound round the inner tube 38, and the outer tube 36 is made of a transparent plastic material, so as to protect the structure of said transmission cable 35.

In this way, when a current is supplied to the power cord 36, the electro-luminescent materials 39 will produce high-pressure collisions of electrons from the electric current, and thus stimulate the photon reaction and produce a light which can achieve uniform light effects at a luminous intensity of 360 degrees; however, this photon will become ionized only on the powdered surface, and if stimulation is continuously applied to the power cord 36, the photon will continue to be ionized on its surface, so that the user can detect if the signal transmission status of the transmission cable 35 is normal by detecting the luminescence of electro-luminescent materials 38.

While the invention has been described by way of examples and in terms of preferred embodiments, it is to be understood by those who are familiar with the prior art that the invention is not limited thereto. To the contrary, it is intended to carry out various modifications and similar arrangements and procedures, and the scope of the appended claims therefore should be accorded the broadest interpretation so as to encompass all such modifications and similar arrangements and procedures.

1. A USB transmission cable having a power display, comprising a computer-end plug and a device-end plug, wherein said device-end plug internally comprises a signal detection-and-display circuit, and said circuit drives an indicator to indicate the power supply status of said USB transmission cable.

2. The USB transmission cable having a power display as claimed in claim 1, wherein said computer-end plug can plug into the USB port of a first electronic device, and said device-end plug can plug into the USB port of a second electronic device.

3. The USB transmission cable having a power display as claimed in claim 1, wherein said signal detection-and-display circuit comprises a light-emitting diode and a resistor, and wherein said light-emitting diode and said resistor are connected in series between the power wire and the ground wire.

4. The USB transmission cable having a power display as claimed in claim 1, wherein said signal detection-and-display circuit comprises a transistor and a light-emitting diode, wherein the base of said transistor is connected to the data wire via a resistor; the collector of said transistor is connected in series to said light-emitting diode and a resistor and then connected to the power wire; the emitter of said transistor is connected to the ground wire.

5. A USB transmission cable having a power display, comprising a computer-end plug, a device-end plug, and a transmission cable, wherein said transmission cable comprises an inner tube and an outer tube, and the interior of said inner tube comprises the signal wires between said computer-end plug and said device-end plug, a power wire is wound round the external surface of said inner tube, and electro-luminescent materials are filled between said outer tube and said inner tube; once the power wire is energized, said electro-luminescent materials are caused to become luminescent.

6. The USB transmission cable having a power display as claimed in claim 5, wherein said computer-end plug can plug into the USB port of a first electronic device, and said device-end plug can plug into the USB port of a second electronic device.
